(19) United States
(12) Patent Application Publication
(10) Pub. No.: US 2015/0019662 A1
(43) Pub. Date: Jan. 15, 2015

(54) Notification Message Generation

(71) Applicant: Other Levels Pty Ltd, ACN 155 113 438, Brisbane, Queensland (AU)

(72) Inventors: Brendan O'Kane, Bardon (AU); Timothy Marks, Toowong (AU); Rene Wooller, Bulimba (AU)

(21) Appl. No.: 14/380,017

(22) PCT Filed: Feb. 20, 2013
(86) PCT No.: PCT/AU2013/000147

§ 371 Date: Aug. 20, 2014

(30) Foreign Application Priority Data
Feb. 20, 2012 (AU) 2012900612

(51) Int. Cl. G06F 17/24; H04L 29/08

(52) U.S. Cl. CPC G06F 17/248; H04L 67/10
USPC 709/206

(57) ABSTRACT

The disclosure concerns notification message generation. A first message template is generated based on a series of first notification messages intended for push delivery to recipient user devices. The first message template includes non-personalised information identified as substantially common to the series of first notification messages, and one or more parameters representing personalised information identified in the stream of first notification messages. An alternative second message template that includes at least one variation from the non-personalised information in the first message template is then generated. Using the first message template and second message template, a series of second notification messages is generated for push delivery to the recipient user devices. Generating the second notification messages includes replacing the one or more parameters with personalised information associated with the recipient user devices. Based on usage information of the second notification messages, it is determined whether the first message template or the second message template is more effective.

### TECHNICAL FIELD

This disclosure concerns a computer-implemented method, computer system and computer program for notification message generation.

### SUMMARY

According to a first aspect, there is provided a computer-implemented method of notification message generation, the method comprising a processing unit:
(a) generating a first message template based on a series of first notification messages intended for push delivery to recipient user devices, wherein the first message template includes non-personalised information identified as substantially common to the series of first notification messages, and one or more parameters representing personalised information identified in the stream of first notification messages;
(b) generating an alternative second message template that includes at least one variation from the non-personalised information in the first message template;
(c) using the first message template and second message template, generating a series of second notification messages for push delivery to the recipient user devices, wherein generating the second notification messages includes replacing the one or more parameters with personalised information associated with the recipient user devices; and
(d) based on usage information of the second notification messages, determining whether the first message template or the second message template is more effective.

Generating the second message template may comprise varying the non-personalised information and/or one or more parameters identified in the first message by applying a set of one or more transformations on the first message template.

In this case, the set of one or more transformations may include one or more of the following:
replacing a word in the first message template with a different word;
changing a style of the first message template;
reordering sentences in the first message template; and
removing a parameter in the first message template.

Additionally or alternatively, the set of one or more transformations may include one or more of the following:
changing an urgency level of the first message template;
changing a style of the first message template based on an age group associated with the recipient user devices;
changing an intimacy level of the first message template;
changing a level of euphemism of the first message template;
changing a stylistic or punctuation component in the first message template;
changing a leetspeak level of the first message template;
changing an abbreviation level of the first message template;
changing a letter case of the first message template;
changing a type-to-token ratio of the first message template;
changing a level of hard or soft selling of the first message template; and
changing a level of popular culture reference of the first message template. changing a level of stylistic influence from a range of subcultures.

A mode or degree of a transformation in the set may be adjustable by setting a continuous or discreet transformation parameter.

The set of one or more transformations may be determined dynamically.

The method may further comprise:
generating the second message template by applying the set of one or more transformations on the first message template iteratively; and
each iteration comprises applying a transformation in the set to generate multiple candidate second message templates, and selecting one of the candidate second message templates for the next transformation until transformation is complete.

At each iteration, one of the candidate second message templates may be selected for the next transformation based on one or more relatedness measures between each candidate second message template and a target message template. In this case, the one or more relatedness measures may include one or more of the following:
a similarity measure relating to dialect usage;
a distance measure relating to number of edit operations required to modify the candidate second message template into the target message template;
a similarity measure relating to number of matching n-gram strings; and
a similarity measure relating to length of words and/or sentences.

The method may further comprise:
assigning a first weighting factor to the first message template and a second weighting factor to the second message template, the first and second weighting factors each representing an average rate at which second notification messaged are generated from the respective message templates;
generating the series of second notification messages based on the assigned weighting factors; and
based on whether the first message template or the second message template is more effective, adjusting the first weighting factor and the second weighting factor.

The method may further comprise, based on whether the first message template or the second message template is more effective, generating a third message template having at least one variation from the first message template or second message template, and replacing the first message template or the second message template with the third message template.

The first message template and the second message template may be each associated with one of the following:
a day on which a second notification message generated from the message template should be sent;
a time at which a second notification message generated from the message template should be sent;
a user cohort associated with a user device to which a second notification message generated from the message template should be sent;
a location associated with a user device to which a second notification message generated from the message template should be sent; and
a software platform associated with a user device to which a second notification message generated from the message template should be sent.

The second notification messages may be embedded with information gathering capability to collect the usage information at the user devices.

The method may further comprise deriving, from on the usage information, one or more of the following:
whether a second notification message is opened, or not opened, at a user device if sent at a particular time or day, or both;
whether a second notification message is opened, or not opened, at a user device associated with a particular software platform;
whether a second notification message is opened, or not opened, at a user device associated with a particular user cohort; and
whether a second notification message is opened, or not opened, at a user device associated with a particular location.

The method may further comprise deriving, from the usage information, user cohorts each relating to one or more of the following:
a time or day on which a second notification message is opened or not opened;
a location where a second notification message is opened or not opened;
type of user response to a second notification message; and
a property of a user device at which a second notification message is opened or not opened.

The one or more parameters in the first message template or second message template may be each represented as a reference character sequence.

The first notification messages may be generated by an application server and the second notification messages are sent to the user devices by a notification server. The second notification messages may be generated when a request message is received from the application server.

According to a second aspect, there is provided a computer program comprising computer-executable instructions that cause a computer system to implement the method of notification message generation according to the first aspect.

According to a third aspect, there is provided a computer system of notification message generation, the computer system comprises a processing unit operable to:
(a) generate a first message template based on a series of first notification messages intended for push delivery to recipient user devices, wherein the first message template includes non-personalised information substantially common to the series of first notification messages, and one or more parameters representing personalised information identified in the stream of first notification messages;
(b) generate an alternative second message template based on the first message template, wherein the second message template includes at least one variation from the first message template;
(c) using the first message template and second message template, generate a series of second notification messages for push delivery to the recipient user devices, wherein generating the second notification messages includes replacing the one or more parameters with personalised information associated with the recipient user devices; and
(d) based on usage information of the second notification messages, determine whether the first message template or the second message template is more effective.

### BRIEF DESCRIPTION OF DRAWINGS

Non-limiting example(s) of the method and system will now be described with reference to the accompanying drawings, in which:

FIG. 1 is a schematic diagram of an example network environment for generation of push notification messages;

FIG. 2 is a flowchart of an example method for notification message generation;

FIG. 3 is a flowchart of an example method for generating a second message template using an iterative transformation process;

FIG. 4 is a schematic diagram of example transformations applied on a first message template;

FIG. 5(a) is a schematic diagram of a first example of push delivery of notification messages where the message server in FIG. 1 serves as a transparent proxy; and

FIG. 5(b) is a schematic diagram of a second example of push delivery of notification messages where the message server in FIG. 1 provides a request message API.

### DETAILED DESCRIPTION

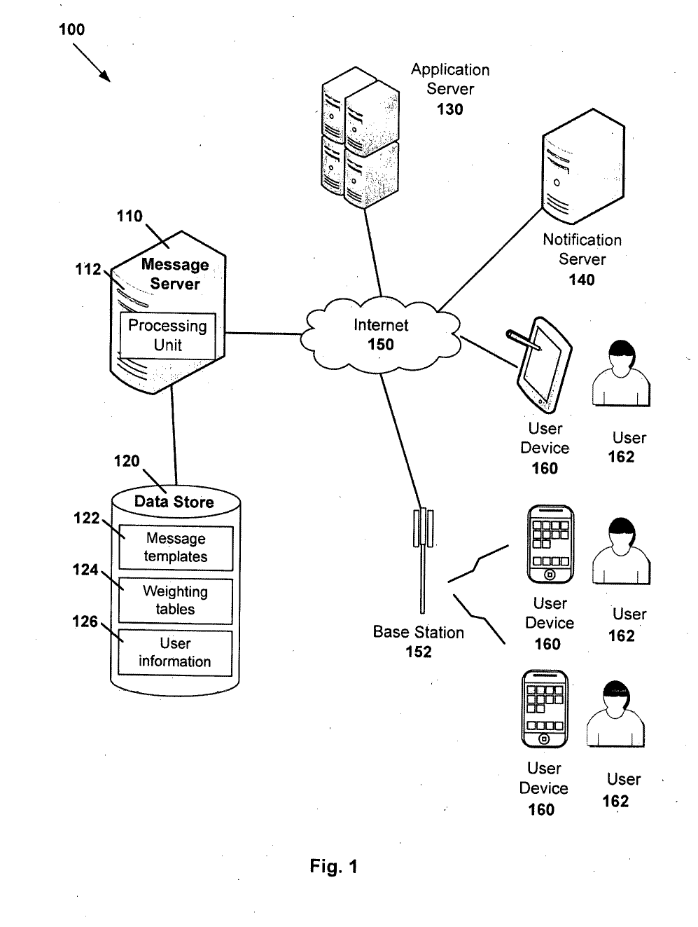

FIG. 1 shows an example of a network environment 100 for notification message generation, in which a message server 110 comprising a processing unit 112 is connected to an application server, 130 and a notification server 140 over a wide area communications network 150 and a mobile communications network 152. A data store 120, accessible by the processing unit 112 of the server 110, stores information associated with notification message generation, such as message templates 122, weighting tables 124 and user information 126.

The application server 130 schedules or generates notification messages (“first notification messages”) for push delivery to the recipient user devices 160. The application server 130 is also responsible for managing information of the user devices, 160 and users or recipients 162. For example, the application server 130 maintains user information 126 such as contact information (phone number, email address, user device identifier, social media account identifier or any other suitable user identifier), and updates the user information 126 as required.

The message server 110 is deployed between the application server 130 and the user devices 160 to enhance notification message generation. Based on first notification messages generated by the application server 130, the message server 110 is operable to generate a first message template and one or more alternative second message templates each having a variation from the first message template.

Using the message templates, notification messages (“second notification messages”) can then be generated for push delivery to the user devices 160. The second notification messages are sent by the message server 110 to the notification server 140, either directly or via the application server 130, for push delivery to the users 162. The second notification messages may also be sent by the application server 130 or any other server in communication with the message server 110.

Advantageously, using the message templates, multiple variations of the same notification message can be generated without having to modify any software code at the application server 130. It will be appreciated that the first and second message templates are generated by the message server 110 automatically without requiring, for example, a user to manually select specific parts of the messages for transformation or manually define how the specific parts are transformed. Further, evaluations such as A/B testing, multivariate or split bucket testing can be performed based on the notification messages generated from different message templates. Usage information of the notification messages is tracked and analysed to determine which of the first and second message templates is most effective. Having this intelligence, subsequent push delivery may be enhanced to improve response rate and effectiveness of the notification messages.

It will be appreciated that any references to a “notification message” in this disclosure refer to a message with binary or digital, content from which message templates can be generated, such as a push notification, web notification, short messaging service (SMS) message, multimedia message (MMS), electronic mail (with a subject line), etc. The notification messages may contain advertising material.

For example, in the case of push notifications, the notification messages may be delivered using any suitable push notification services, such as Apple Push Notification. Service (APNS) for iPhone user devices, Google Cloud Messaging (GCM) for Android user devices, Microsoft Push Notification Service for Windows user devices, and Blackberry Push Service for Blackberry user devices etc. Push delivery may also occur by way of SMS, MMS, and email delivery. A user device 162 may also be any other suitable computing device, such as a portable computer, tablet computer, laptop computer, desktop computer and mobile communication device.

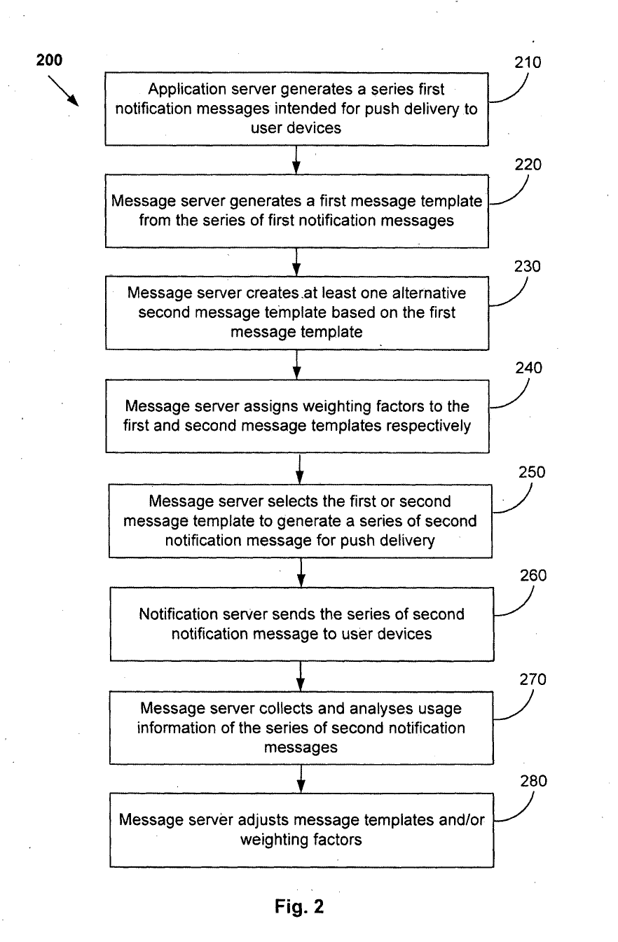

Notification message generation and push delivery will now be explained further with reference to the flowchart 200 in FIG. 2.

### Notification Messages Creation 210

The application server 130 generates first notification messages for push delivery to the user devices 160; see block 210 in FIG. 2.

The first notification messages contain content specified by content providers, and may include text, audio, video and links to webpages. The content may be specified, for example, using a computer interface accessible by the content providers over the Internet. The first notification messages may be sent as part of an audience engagement strategy, marketing campaign, marketing program, advertising plan or the like. In general, the first notification messages may be electronic coupons, vouchers or any messages that can trigger advertising, audience engagement, marketing outcomes etc. The first notification messages may be sent to a particular user cohort, which represents a set of users 162 and their attributes or behaviours. A user may be a member of more than one user cohort.

### Generation of First Message Template 220

The message server 110 generates a first message template from the first notification messages received from the application server 130; see block 220.

Generation of the first message template includes the message server 110 automatically determining whether the first notification messages contain any parameters or personalised information. In one example, consider the following first notification message:
“Welcome to our app. We hope you enjoy it”.

In this case, since the first notification message is a generic message without any parameters, the first message template generated by the message server 110 is also non-personalised or non-parameterised, as follows:
“Welcome to our app. We hope you enjoy it”.

In another example, the message server 110 receives a series of first notification messages, as follows:
“Welcome to our app Tim. We hope you enjoy it”
“Welcome to our app Bruce. We hope you enjoy it.”
“Welcome to our app Jane. We hope you enjoy it.”
“Welcome to our app Jo. We hope you enjoy it.”

In this case, the message server 110 recognises that ‘Tim’, ‘Bruce’, ‘Jane’ and ‘Jo’ are personalised information or parameters in the messages, and other words as non-personalised information. In this case, the non-personalised information includes phrases “Welcome to our app” and “We hope you enjoy it” that are substantially common to the series of first notification messages. Here, “substantially common” includes minor deviations in the series such as spelling and spacing etc.

The message server 110 generates the following first message template with the identified non-personalised information and personalised information. Reference character sequence ‘$1’ represents a parameter (in this case, name) identified from the messages:
“Welcome to our app $1. We hope you enjoy it.”

The first message template may have more than one parameter. For example, consider the following first notification messages:
“Hey Tim, there is a cheap deal waiting inside our Sydney store”
“Hey Bruce, there is a cheap deal waiting inside our Melbourne store”
“Hey Jane, there is a cheap deal waiting inside our Adelaide store”
“Hey Jo, there is a cheap deal waiting inside our Sydney store”

In this case, the message server 110 analyses the content of the notification messages to determine whether they are parameterised, and generates the following first message template:
“Hey $1, there is a cheap deal waiting inside our $2 store”,
   where ‘$1’ refers to a first parameter having the values of ‘Tim’, ‘Bruce’, “Jane′ and ‘Jo’, while ‘$2’ refers to a second parameter having the values of” ‘Sydney’, ‘Melbourne’ and ‘Adelaide’. These parameter-value pairs may be stored in the data store 120, such as for later use when notification messages are generated from the generated message template.

Although character sequences ‘$1’ and ‘$2’ have been used in the above examples, it should be understood that other types of references may be used, such as ‘%1’, ‘*1’, ‘#2’, ‘$name’ and ‘Vocation’.

### Generation of Second Message Templates 230

The message server 110 then generates one or more second message templates as alternatives based on the first message template; see block 230 in FIG. 2. The first and second message templates by the message server 110 are stored in the data store 120; see block 122 in FIG. 1.

### (a) Set of Transformations

The one or more second message templates are generated automatically, each containing at least one variation from the first message template. The message server 110 may vary the non-personalised information and/or parameters by applying a set of one or more transformations on the first message template. Any suitable type of stylistic or substantive transformation may be used.

The set of transformations may include one or more of:
replacing a word in the first message template with a different word;
changing a style of the first message template;
reordering sentences in the first message template; and
removing a parameter in the first message template.

For example, the message server 110 generates the following second message templates based on first message template “Welcome to our app $1. We hope you enjoy it”:
Hi $1. Nice to see you, enjoy our app!”
Hey $1, you look new. Welcome to our app!
How is it going new guy? Come on in!

In another example, the following second message templates are generated based on first message template “Hey $1, there is a cheap deal waiting inside our $2 store”:
Hey $1, there is a cheap deal waiting inside $2
Hey $1, there is a bargain deal waiting inside $2
Hey $1, there is a cheap offer waiting inside $2
Hey $1, there is a bargain offer waiting inside $2

Alternatively or additionally, the set of transformations include one or more of the following:
(1) Urgency creator—for changing an urgency level of the message template based on a continuous parameter representing the urgency level from 0.0 (not urgent) to 1.0 (maximum urgency). For example, “summer sale—20% off” maybe transformed into “Hurry! Summer sale—20% off. Ends soon!” the closer it gets to the end date.
(2) Generationifier—for changing a style of the message template based on an age group associated with the recipient user devices 160. For example, this transformation may involve substituting words, phrases and structures based on a target generation. The transformation is based on a discreet parameter: target age: 5-80.
(3) Intimatizer—for changing an intimacy level of the message template. For example, “summer sale—20% off”′ may be transformed into “psst—there's a 20% off summer sale. Good luck $ame” to add a sense of intimacy to the message template. The transformation may take a continuous parameter representing the intimacy level from 0 (none) 1.0 (maximum).
(4) Euphamizer—for changing a level of euphemism of the message template. The transformation may involve detecting words that have positively or negative connotations and substituting them for words that are of the specified shift in valency. For example, “good′ may be transformed into become ‘great’ or ‘fantastic’ depending on whether the valency was +0.5 or +0.8. The transformation may take a continuous parameter representing the valency, range −1 to +1.
(5) Punctualizer—for changing a stylistic or punctuation component in the message template. The transformation may involve adding or removing a range of” stylistic and punctuation mark components. For example ‘brackets’, ‘0.5’ will add [$campaign subject] or [Scompany] to the beginning of the message. ‘exclamation’, ‘0.5’ convert full stops to exclamation marks for half the sentences, selected for likelihood through previous analysis of real messages with exclamation marks. The transformation may take the following parameters:
   i. Mark type: ‘brackets’, ‘exclamation’, ‘comma’, ‘and’, ‘padding characters’ (e.g. ‘ooOOoo00oo’, ‘˜˜<3’)
   ii. Amount: 0-1.0 controls how prevalent the given mark will be in the message template.
(6) Leetalizer—for changing a leet speak level of the message template, i.e. convert text to and from leet speak. For example, “awesome game package just for you, $name” may be transformed into leet speak “Aw3s0me g4m3 p4ck4ge ju5+ f0r you, $name”. The transformation may take a continuous parameter to control the percentage of leet speak tokens amongst those that are able to be substituted between amount: 0 (none)-1.0 (maximum).
(7) Abbreviator—for changing an abbreviation level of the message template such that text may be converted to and from abbreviated forms that are commonly used in the text messaging paradigm. For example, “Special Christmas sale, just for you” may be transformed into “Special Xmas sale, just 4 U”. The transformation may take a continuous parameter to control the severity of abbreviations, from 0 (none)-1.0 (maximum).
(8) Case masher—for changing a letter case of the message template. The transformation may take the following discrete parameters:
   Mode: 1=transform all letters, 2=transform first letter of each word, 3=transform first letter of each sentence, 4=transform every second letter in certain words; and
   Case: 1=Upper, 2=Lower
(9) Type-to-token shifter—for changing a type-to-token ratio of the message template. Type to token ratio is a measure of vocabulary variation within the message template. This transformation involves calculating the word type-to-token ratio of the message template and performing substitutions on phrases or words to achieve a different type-to-token ratio. For example, in “Hard to imagine a better deal. Jump in quick before the deal is over!”, the type-to-token ratio could be increased with “Hard to imagine a better deal. Jump in quick before the opportunity is over!” This transformation is more applicable to longer text strings. The transformation may take a continuous parameter to control the type-to-token ratio shift, range 0.5 to 2.0, i.e. the factor by which the type to token ratio will be shifted by.
(10) Hard-soft seller—for changing a level of hard or soft selling of the message template. The transformation may be based on a dictionary of terms, phrases, structures and punctuation marks that are known to invoke a softer or harder sell, and substitutions are made to any degree of softness or hardness. The transformation may take a continuous parameter to control the level between 0 (soft) and 1.0 (hard).
(11) Popculture maker—for changing a level of popular culture reference of first message template. For example, “Hey blame, it's going to be a wet season, time to buy a quality Umbrella” may be transformed into “Hey blame, it's going to be a wet season, time to buy a quality Umbrella; ella, ella, e, e . . . ” in reference to the song “Umbrella”. A discreet parameter may be used to specify the type of popculture reference used, and a continuous parameter to specify the degree of the transformation.
(12) Stylistic influencer—for changing a level of stylistic influence from a range of subcultures. For example, “It's going to be a wet season, time to buy a quality Umbrella” may be transformed into “It's gwan be wet dis season. Time to get de fine Umbrella.”, “It's tipped to be rainful, what? The time to purchase a quality Parasol has come!” and “'s gonna soak this wet. Git yur fancy brolly now” highlighting different subcultures. A continuous parameter is used to specify the level of stylistic influence to control the degree of the transformation.

In one example implementation, the set of transformations may be dynamic, in that the message server 110 dynamically determines the transformations that should be included in the set. For example, the rules for transformations may be adapted in response to a live corpus of data from the web. In addition, new transformations may be plugged into this dynamic architecture at any time, and existing transformations removed in real time. The influence of one transformation over another may also be dynamically altered in real time, both manually and by an optimisation process. The set of transformations may be determined based on user cohorts and attributes of the recipients 162.

Advantageously, the dynamic set allows the flexibility to generate a limitless amount of variations, depending on a range of contexts. The mode or degree of each transformation in the set is adjustable by setting a continuous or discreet transformation parameter. Transformations could be tagged with different attributes or topics that affect how they are applied. The influence of each transformation is also adjustable by adjusting an associated weighting factor, such as between 0.0 (no influence) to 1.0 (heaviest influence).

### (b) Iterative Transformation

The set of transformations may be represented as follows, where N is the number of transformations in the set:
T={T₁, T₂, . . . , T_{N}}.

Since the mode or degree of each transformation may be adjusted by changing its discreet or continuous parameter, the set of transformations may be further expanded as follows:
T′={T₁₁, T₁₂, . . . , T_{1N}_{₁}}∪{T₂₁, T₂₂, . . . , T_{2N}_{₂}}∪ . . . ∪{T_{N1}, T_{N2}, . . . , T_{NN}_{_{N}}}.

Here, {T₁₁, T₁₂, . . . , T_{1N}_{₁}} represents the set of variations that can be generated from the first transformation T₁, and so on, and N₁ is the number of variations.

Having a large number of transformations with many different values for parameters presents a problem of scale—how does the message server 110 select the most appropriate second message template from the set of all candidate second message templates generated based on the first message template?

To put this scalability problem in context, all possible permutations of just 50 transformations is 3e+64. Including an average of two parameters for each transformation with a range of 10 discreet values, this becomes 2.8e+149. To be useful in practice, this should be reduced to just 5 or so possible variations of the first message template.

To reduce the size of the problem, an iterative message template transformation process may be used, in which the set of transformations may be applied on the first message template iteratively. Each iteration includes applying one of the transformations to generate multiple candidate second message templates and selecting one of them for the next transformation. This is repeated until transformation completes.

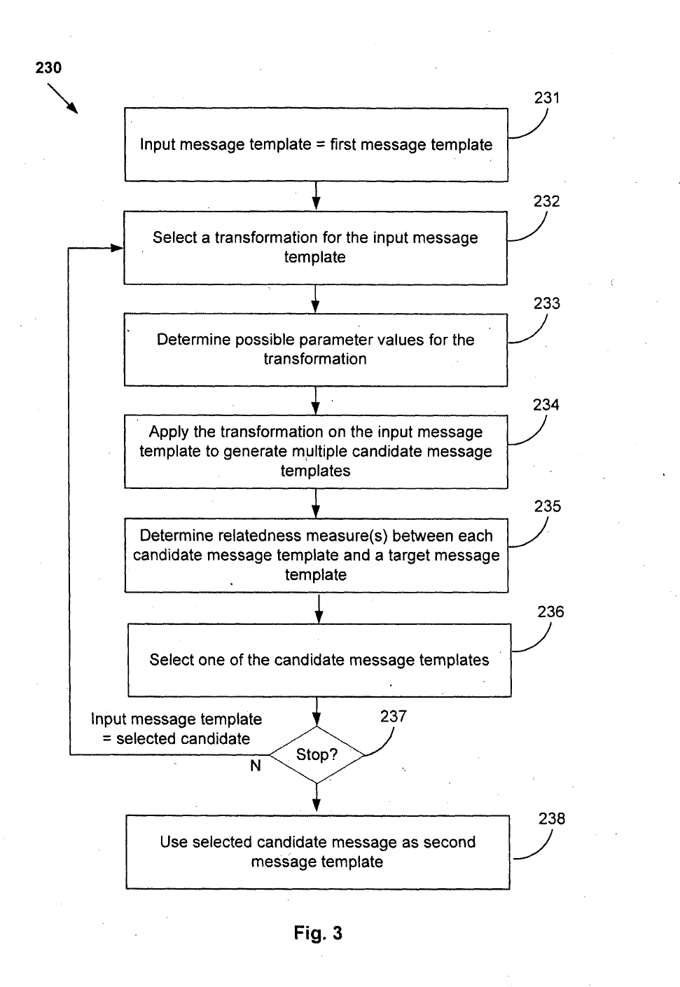

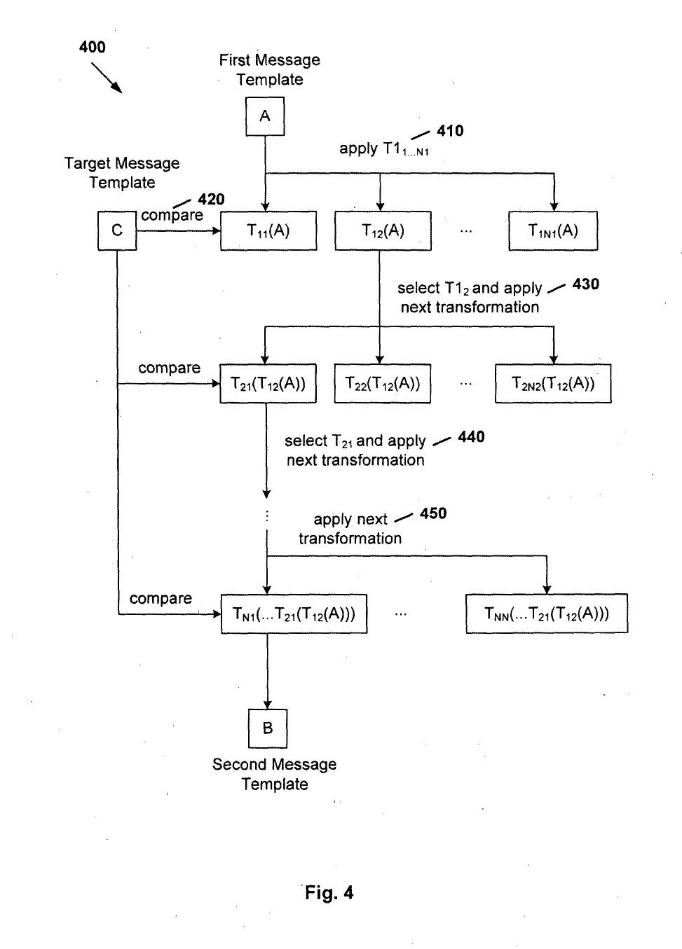

An example of the iterative process performed by the message server 110 will now be explained using FIG. 3 and FIG. 4.
At block 231 in FIG. 3, which represents the first iteration, the first message template is set as the input message template to be transformed. In the example in FIG. 4, the following first message template is represented as ‘A:
   A: “Hey $name, there is a cheap deal waiting inside $app”
At block 232 in FIG. 3, a transformation is selected for the input message template from the set of transformations, T={T₁, T₂, . . . , T_{N}}. The transformation may be selected in series from the set, or in a random manner. In the example in FIG. 4, transformation T₁=urgency creator is first selected.
At block 233 in FIG. 3, possible parameter values for transformation T₁ are determined. In this case, the continuous parameter of T₁ may take values between 0.0 and 1.0.
At block 234 in FIG. 3, the transformation is applied on message template ‘A’ to generate multiple candidate message templates. See also 410 in FIG. 4. Using a simple example with urgency levels 0.5 and 0.8, the candidate message templates in this iteration are:
   T₁₁(A): “Hey $name, there is a limited time offer waiting inside $app, and it's almost sold out.”
   T₁₂ (A): “Hurry, $name! Cheap deal inside $app. Won't last long!”
At block 235 in FIG. 3, one or more relatedness measures between each candidate message template and a target message template are determined. Advantageously, the relatedness measures facilitate dynamic pruning of permutations generated by the set of transformations.
The relatedness measures may also be used in a message template morphing process, in which the message server 110 morphs any given message templates towards other message templates that are known to be effective templates. For example, the target may be the most effective message template from a previous campaign, as represented as ‘B’ in FIG. 4:
   C: “DUDE, WE'RE CRAZY! 20% off—storewide SALE!”
The relatedness measures may include similarity and/or distance measures. The latter are useful in situations where the similarity measures are unhelpful. For example, the relatedness measures may include one or more of:
   (i) Dialect similarity, which is a similarity measure relating to dialect usage. This is for counting matches of words and phrases in the message template to different collections of words used in various dialects, such leet speak, txt (SMS language) dialects, Australian English, plain English, different generations and so on. The greater amount of similar matches to the same dialect, the closer the dialectical similarity is.
   (ii) Edit distance, which is a distance measure relating to number of edit operations required to modify the candidate second message template into the target message template. This is for counting the number of word, phrase, lexo-morphological or syntactic substitutions, additions, removals, and shifts that would be required to before one message becomes the other. The greater the count of operations, the greater the edit distance is.
   (iii) N-gram similarity, which is a similarity measure relating to number of matching n-gram strings.
   (iv) Wordiness similarity, which is a similarity measure relating to length of words and/or sentences.
At block 236 in FIG. 3, one of the candidate message templates is selected based on the one or more relatedness measures. Using the wordiness similarity measure, the average word per sentence of T₁₁(A) is 14, T₁₂(A) is 3 and C is 3.5.
The candidates are ranked according to their similarity measure and in this case, T₁₂(A) would be ranked closest to the target C. Assuming that other relatedness measures return the same result, target C is selected for the next transformation. See 420 and 430 FIG. 4.
At block 237 in FIG. 3, the message server 110 checks whether a stopping criterion has been met. For example, the message template transformation checks whether there is at least one transformation that has not been performed.
If yes, the selected candidate T₁₂ (A) is used as an input message template for the next transformation, and blocks 232 to 237 are repeated. For example, using T₂=Generationifier as the next transformation, the candidate message templates are:
   T₂₁(T₁₂(A)): “Hi ho, $name! Cheap deal inside $app. Won't last long!”
   T₂₄ (T₁₂(A)): “Dude! Cheap deal inside $app. Won't last long!”
In this case, T₂₄(T₁₂(A)) matches C on the dialectical similarity measure—assuming the other similarity measures are similar in this case, T₂₄(T₁₂(A)) is then selected for the next transformation. This process repeats for all transformations and permutations. See also iterations 440 and 450 in FIG. 4.
Once all iterations have been performed, the candidate selected at the final iteration is used as the second message template; see block 238 in FIG. 3. Of course, multiple second message templates may be generated. The second Message template(s) are then added to a list of suggested variations of the first message template or used as inputs to an auto-optimisation split testing algorithm.

The speed at which the morphing takes place may be controlled. In some cases, the first message template is already similar to the target, and it is more desirable to obtain transformations that are ranked lesser, so as to obtain greater variation. In this case, the ‘morph speed’ will ensure that transformations are selected based on a desired rate of similarity increase to the target, rather than only selecting from the highest ranked messages.

In the above, the second message templates may be generated by the message server 110 with reference to dictionary, thesaurus and common word replacement. Natural language and artificial intelligence methods may be used to derive semantic information from the first message template to generate the second message templates. The generation of the second message templates may be based on a collection of notification messages that has been previously analysed, and the usage information collected at block 270 below. An iterative process may be used to generate the second message templates based on metrics calculated by the message server 110, such as open rates, non-open rates, click-through rates to assess the effectiveness of the message templates; see block 270 below.

### Assignment of Weighting Factors 240

The message server 110 then assigns a weighting factor to each of the first and second message templates; see block 240 in FIG. 2.

In one implementation, the message server 110 creates a weighting table for the first and second message templates. Using the examples in the previous section, the message server 110 creates the following weighting tables. As exemplified in Table 2, the weighting factors do not have to be the same, but sum up to 100%.

TABLE 1(a)

| Weighting | | |
|---|---|---|
| factor | Message Template | Type |
| 25% | Welcome to our app $1. We hope you enjoy it. | First |
| 25% | Hi $1. Nice to see you, enjoy our app! | Second |
| 25% | Hey $1, you look new. Welcome to our app! | Second |
| 25% | How is it going new guy? Come on in! | Second |

TABLE 1(b)

| Weighting | | |
|---|---|---|
| factor | Message Template | Type |
| 40% | Hey $1, there is a cheap deal waiting inside $2 | First |
| 20% | Hey $1, there is a bargain deal waiting inside $2 | Second |
| 30% | Hey $1, there is a cheap offer waiting inside $2 | Second |
| 10% | Hey $1, there is a bargain offer waiting inside $2 | Second |

A weighting factor represents the average number of times or rate at which the respective message template is selected for generating a second notification message for push delivery. For example, over a spread of 100 messages sent, each message template in Table 1(a) is expected to be selected 25 times. As for Table 1(b), the message templates are, on average, selected 40, 20, 30 and 10 times respectively over a spread of 100 messages. Certain standard variations may be taken into account.

### Push Delivery 250, 260

Once the first and second message templates have been derived, the message server 110 selects one of the message templates and generates a second notification message using the selected message template; see block 250 in FIG. 2. Any parameter(s) in the template will be substituted by parameter values of the recipient user devices 162.

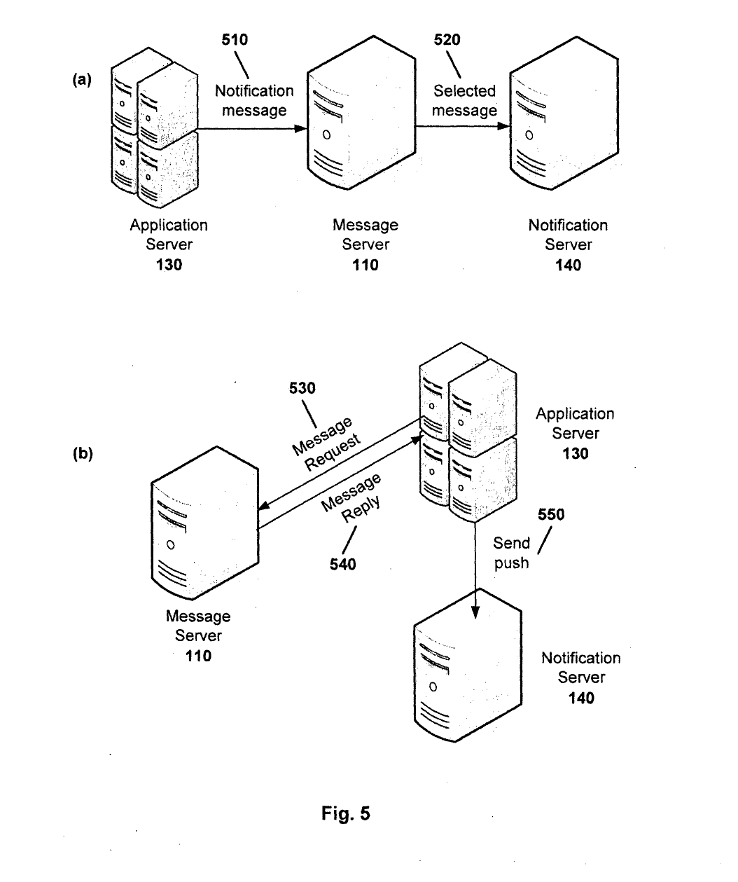

The second notification message is then sent, by the message server 110 or application server 130, to the notification server 140 for push delivery to a user device; see blocks 250 and 260 in FIG. 2. In particular, the push delivery may be implemented as follows:
(a) Transparent Proxy
In one example implementation in FIG. 5(a), the message/server 110 serves as a transparent proxy between the application server 130 and the notification server 140.
In this case, every time the application server 130 sends a first notification message intended to a user device 160 in FIG. 1, the message server 110 will “intercept” the first notification message; see 510 in FIG. 5. The message server 110 then determines whether message templates have already been generated for the first notification message.
If the message templates already exist, the message server 110 retrieves the message templates and selects either the first (representing the original message) or a second message template (representing an alternative message) for push delivery. The selection is based on the weighting factors assigned to the respective message templates. Otherwise, if there are no message templates, the message server 110 generates the first and second message templates according to 220 to 240 in FIG. 2 prior to the selection.
The second notification message is then sent to the notification server 140 for push delivery to one or more user devices 160; see block 520 in FIG. 5.
(b) Request message API
In another example implementation shown in FIG. 5(b), the message server 110 provides a request message application programming interface (API) for the application server 130.
In this case, every time the application server 130 wishes to push a first notification message, the application server 130 sends a message request to the message server 110; see block 530 in. FIG. 5. The message request includes information identifying the first notification message, which is used by the message server 110 to determine whether first and second message templates have already been generated for the notification message.
Similar to (a), if the message templates already exist, the message server 110 retrieves the message templates and selects either the first (representing the original message) or a second message template (representing an alternative message) for push delivery. The selection is based on the weighting factors assigned to the respective message templates. Otherwise, if there are no message templates, the message server 110 generates the first and second message templates according to 220 to 240 in FIG. 2 prior to the selection.
The second notification message is then sent to the application server 130 in the form of a message reply; see block 540 in FIG. 5. The application server 130 then sends the second notification message to the notification server 140 for push delivery to one or more user devices 160; see block 550 in FIG. 5.

Although not shown in FIG. 5, the notification server 130 may also be sending the second notification messages to the user devices 160.

Prior to sending the second notification message to the notification server 140 in FIG. 5(a) or the application server 130 in FIG. 5(b), the message server 110 embeds information collection capability in the second notification message to collect usage information of the second notification message when it arrives at a user device 160 in FIG. 1. The information collection capability may be in the form of a unique hash embedded in the selected message. The unique hash may be embedded in the message metadata, message properties or within a uniform resource allocator (URL) contained in the message, for example. Note that if the first message template is selected, the content of the second notification message would be the same as the first notification message received from the application server 130. Otherwise, if a second message template is selected, the second notification message serves as a replacement or substitution for the first notification message.

### Usage Information Collection and Analysis 270

The message server 110 monitors all second notification messages sent and collects usage information through the information collection capability embedded in the messages; see block 270 in FIG. 2. Using the collected usage information, the message server 110 determines which of the first and second message templates is more effective than others.

For example, the determination may be made based on one or more of the following metrics derived from the usage information:
open rate, which is the rate at which a particular second notification message, and therefore the corresponding message template, is opened and calculated by dividing the number of times the message is opened by the number of times the message is sent;
non-open rate, which is the rate at which a particular second notification message, and therefore the corresponding message template, is not opened and calculated by dividing the number of times the message is not opened at a user device 160 by the number of times the message is sent;
click-through rate, which is the number of times any recipient 160 clicks on a link within the second notification message and calculated by dividing the number of click-throughs detected divided by the number of times the message is sent;
occurrence of a certain event(s), which is the raw number of occurrence of certain event(s) such as a purchase or registration after opening a message;
weighted occurrence of a certain event(s), which is the raw number of occurrence of certain event(s) weighted by a certain factor such as the number of message opened; and
any combination of the above, such as a combination of event and open rates.

The effectiveness of the message templates may be measured using a variety of metrics, including but not limited to open rates and open rates weighted by the weighting factor (% distribution). For example, consider the following open rates of the messages generated from the message templates in Table 1(a) and Table 1(b).

TABLE 2(a)

| Weighting | | |
|---|---|---|
| factor | Message Template | Open rate |
| 25% | Welcome to our app $1. We hope you enjoy it. | 10% |
| 25% | Hi $1. Nice to see you, enjoy our app! | 30% |
| 25% | Hey $1, you look new. Welcome to our app! | 70% |
| 25% | How is it going new guy? Come on in! | 50% |

In this case, message template “Hey $1, you look new. Welcome to our app!” has the highest open rate of 70% while message template “Welcome to our app $1. We hope you enjoy it.” is the least opened. The overall effectiveness of the messages in this case is 0.25(0.10+0.30+0.70+0.50)=0.40, which means only 40% of the messages are opened by their recipients 160.

TABLE 2(b)

| Weighting | | |
|---|---|---|
| factor | Message Template | Open rate |
| 40% | Hey $1, there is a cheap deal waiting inside $2 | 20% |
| 20% | Hey $1, there is a bargain deal waiting inside $2 | 40% |
| 30% | Hey $1, there is a cheap offer waiting inside $2 | 20% |
| 10% | Hey $1, there is a bargain offer waiting inside $2 | 10% |

In this case, message template “Hey $1, there is a bargain deal waiting inside $2” has the highest open rate of 40% while message template “Hey $1, there is a bargain offer waiting inside $2” is the least opened. The overall effectiveness of the messages in this case is 0.40*0.20+0.20*0.40+0.30*0.20+0.10*0.10=0.23, which means only 23% of the messages are opened by their recipients 160.

### Push Delivery Enhancement 280

Based on the usage information collected at 270 in FIG. 2, the message server 110 automatically enhances or optimises subsequent push delivery by adjusting the message templates and/or the weighting factors of the message templates.

For example, an evolutionary algorithm may be used in the automatic optimisation process, in which top performing message templates are kept while the least performing message templates are removed or replaced with other variations.

After each round of evaluation, the list of N message templates is reordered according to their performance, for example as indicated by their open, rates from highest to lowest. For example, Table 2(a) is reordered as follows:

TABLE 3(a)

| Weighting | | |
|---|---|---|
| factor | Message Template | Open rate |
| 25% | Hey $1, you look new. Welcome to our app! | 70% |
| 25% | How is it going new guy? Come on in! | 50% |
| 25% | Hi $1. Nice to see you, enjoy our app! | 30% |
| 25% | Welcome to our app $1. We hope you enjoy it. | 10% |

Further evaluations can be run on the sorted message templates, or a subset of the message templates. For example, the number of message templates is retained, the weighting factor of each message template is adjusted to improve the overall effectiveness. In the example in Table 3(b), a weighted algorithm is used, in which weighting factors 40%, 30%, 20% and 10% are assigned to the N=4 message templates.

TABLE 3(b)

| Weighting | | |
|---|---|---|
| factor | | |
| (updated) | Message Template | Open rate |
| 40% | Hey $1, you look new. Welcome to our app! | 70% |
| 30% | How is it going new guy? Come on in! | 50% |
| 20% | Hi $1. Nice to see you, enjoy our app! | 30% |
| 10% | Welcome to our app $1. We hope you enjoy it. | 10% |

In another example shown in. Table 3(c) below, the least performing message template in Table 3(a) is replaced by a new message template “Greetings $1, welcome and enjoy!” having a weighting factor of 10%.

TABLE 3(c)

| Weighting | | |
|---|---|---|
| factor | Message Template | Open rate |
| 40% | Hey $1, you look new. Welcome to our app! | 70% |
| 30% | How is it going new guy? Come on in! | 50% |
| 20% | Hi $1. Nice to see you, enjoy our app! | 30% |
| 10% | Greetings $1. Welcome and enjoy!. | 10% |

It should be understood that the second notification messages may be sent in batches. In general, there might be X number of message templates in total, Y user devices 160 or users 162 representing a total sample size, Z user devices 160 or users 162 representing a subset of the total sample size, N number of message templates used for each batch of Z users (N<=X) and W is a weighted distribution of N templates for Z messages. For example, using Table 4(a):
X=4 message templates generated by the message server 110;
Y=100,000 notification messages to be sent via push delivery to a total sample size 100,000 user devices 160 or users 162 respectively;
Z=10,000 user devices 160 or users 162, which is a subset of the total sample size of Y;
N=4 message templates used for each batch of 10,000; and
W is a weighted distribution of 40%, 30%, 20% and 10% for N=4 message templates for Z=10,000 users.

Each batch of notification messages may represent iteration in the evaluation, the result of which is used to enhance the generation and delivery of notification messages in subsequent batches.

In another example, in relation to the message templates in Table 1(b), they can be reordered as follows according to the calculated open rates:

TABLE 4(a)

| Weighting | | |
|---|---|---|
| factor | Message Template | Open rate |
| 20% | Hey $1, there is a bargain deal waiting inside $2 | 40% |
| 40% | Hey $1, there is a cheap deal waiting inside $2 | 20% |
| 30% | Hey $1, there is a cheap offer waiting inside $2 | 20% |
| 10% | Hey $1, there is a bargain offer waiting inside $2 | 10% |

In one example shown in Table 4(b) below, the least performing message template in Table 1(b) is removed, and the weighting factors of the remaining templates adjusted equally.

TABLE 4(b)

| Weighting | | |
|---|---|---|
| factor | | |
| (updated) | Message Template | Open rate |
| 33.33% | Hey $1, there is a bargain deal waiting inside $2 | 40% |
| 33.33% | Hey $1, there is a cheap deal waiting inside $2 | 20% |
| 33.33% | Hey $1, there is a cheap offer waiting inside $2 | 20% |

Other examples for determining the ‘most effective’ message template(s) are set out below:
(1) The message template(s) with the highest statistically significant (e.g. standard deviation+−5%) open rates.
If one message template outperforms all others, then it would be automatically set to 100% to achieve the most positive outcome for message opens. If two or more message templates significantly outperform the others but can't be separated from each other, the poorly performing message template(s) will be set to 0% and the 100% shared between the remaining message template(s). If more than one message is selected here, a second sample may be performed and a second round of optimisation may occur
(2) The message template(s) with the highest (raw metric) occurrence of a certain event(s) from the pushed notification message and/or within a software application (app).
This allows optimisation of the (raw) number of people making a purchase or registering after opening the push message. This is not weighted on the number of messages sent (see (3) below) but a raw highest. If one message outperforms all others then it would be automatically set to 100% to achieve the most positive outcome for event occurrences. If two or more messages significantly outperform the others but can't be separated from each other, the poorly performing messages will be set to 0% and the 100% shared between the remaining messages. If more than one message is selected here, a second sample may be performed and a second round of optimisation may occur
(3) The message template(s) with the highest weighted occurrence of a certain event(s) such as a completed call to action, from the pushed notification message or within a software application (app).
This is the same as (2) but the number of events is weighted based on the percentage of messages sent out as each split. For example, consider 26 purchases/48 opens and 68 purchases/200 opens. While 68 is higher, 26/48 performs better.
(4) The message template(s) with the highest combination of event and open rates. Based on the current open rates, the message template that will result in the highest number of events in total (events/messages*opens/messages) will be chosen.
(5) The message template(s) with the highest weighted value based on weighted events (register 20%, purchase 80%) to produce a weighted Return on Investment (ROI).
(6) The message template(s) ranked highest according to any of the above criteria, but additionally weighted against performance of previous messages within a given time period for example, daily, weekly, monthly, yearly, and over any time period.
(7) The message template(s) ranked highest according to any of the above criteria, but additionally weighted against the performance of previous messages during periods of similar influential news events, automatically derived from new feeds. For example, events such as flood, fire, rain, drought, Australian Football League finals, Chinese New Year, death of celebrities and so on may be used. This will allow greater controls to gauge the performance of the message copy within the broader context of the media.
(8) The message template(s) ranked highest according to any of the above criteria, but additionally weighted against performance of previous messages sent during particular end user activities and schedules, for example, work hours, lunch hours, holidays, night out and weekends.

The message selection 250, push delivery 260, usage information analysis 270 and subsequent adjustment 280 in FIG. 2 may be repeated until the most effective message template or message templates have been determined. This iterative process is performed automatically.

It will be appreciated that although the above examples have been described with reference to open rates derived from the usage information, non-open rates may be similarly used. In this case, the list of N message templates is reordered according to the non-open rates, from lowest to highest. Based on the non-open rates, the message server 110 may similarly reassign the weighting factors according to the order of the message templates, or remove or update the least performing message template(s).

### Additional Enhancement

The effectiveness of the message templates may also be measured using template open rates weighted by other factors including but not limited to: user cohort, device information, day and/or time to open etc.

(a) User cohort

The message server 110 may also use information of the recipients such as their location and demographics to further enhance notification message generation.

For example, the recipients may be divided into two user cohorts (male and female) and the open rate of each message analysed to determine not only the best message template to use, but to whom the message generated from the best message template should be sent.

TABLE 4(b)

| Weighting | | |
|---|---|---|
| factor | Message Template | Cohort |
| 20% | Hey $1, there is a cheap deal waiting inside $2 | Male |
| 20% | Hey $1, there is a cheap deal waiting inside $2 | Female |
| 10% | Hey $1, there is a bargain deal waiting inside $2 | Male |
| 10% | Hey $1, there is a bargain deal waiting inside $2 | Female |
| 15% | Hey $1, there is a cheap offer waiting inside $2 | Male |
| 15% | Hey $1, there is a cheap offer waiting inside $2 | Female |
| 5% | Hey $1, there is a bargain offer waiting inside $2 | Male |
| 5% | Hey $1, there is a bargain offer waiting inside $2 | Female |

In this case, message template “Hey $1, there is a cheap deal waiting inside $2” may be most effective with a male cohort while “Hey $1, there is a bargain deal waiting inside $2” may be most effective with a female cohort.

As such, groups within an A/B test can be tracked and measured such that in the case of two mutual winners, there will be a subset of the recipients who responds to A and another subset who responds to B and the A/B test can be further segmented into multiple groups.

The message server 110 may also derive the user cohorts from the usage information collected at block 270. For example, based on the open rates derived at block 270, the message server 110 may derive user cohorts relating to:
(i) user devices 160 that open a second notification message associated with a message template within a specific timeframe, such as within 1 hour, 3 hours, 6 hours and 12 hours of receipt;
(ii) user devices 160 that open a second notification message associated with a message template within a geographical area, such as a suburb, city, state and country; and
(iii) user responses to different campaigns, such as some users 162 may be interested in daily updates, but not an upgrade offer.

More complex cohorts may be derived by the message server 110. Using the above examples, the message server 110 may derive user cohorts relating to user devices 160 that open a second notification message associated with a message template (i) within a specific timeframe, (ii) within a specific geographical area and (iii) responded with an interest in an upgrade offer. Other combination of user cohorts may be used. A user 162 may belong to more than one cohort.

Similarly, the user cohorts may be derived based on non-open rates and click-through rates derived from the usage information. For example, based on the non-open rates derived at block 270, the message server 110 may derive user cohorts relating to:
(i) user devices 160 that do not open a second notification message associated with a message template within a specific timeframe, such as within 1 hour, 3 hours, 6 hours and 12 hours of receipt;
(ii) user devices 160 that do not open a second notification message associated with a message template within a geographical area, such as a suburb, city, state and country; and
(iii) gender of users 162 operating user devices 160 that do not open a second notification message.

### (b) Device

The message server 110 may also track the behaviour and information of a particular user device 160, such as its device type in which case Table 1(a) may be updated as follows:

TABLE 4(c)

| Weighting | | |
|---|---|---|
| factor | Message Template | Device |
| 12.5% | Welcome to our app $1. We hope you enjoy it. | Android |
| 12.5% | Welcome to our app $1. We hope you enjoy it. | iPhone |
| 12.5% | Hi $1. Nice to see you, enjoy our app! | Android |
| 12.5% | Hi $1. Nice to see you, enjoy our app! | iPhone |
| 12.5% | Hey $1, you look new. Welcome to our app! | Android |
| 12.5% | Hey $1, you look new. Welcome to our app! | iPhone |
| 12.5% | How is it going new guy? Come on in! | Android |
| 12.5% | How is it going new guy? Come on in! | iPhone |

In this case, the message server 110 may collect and aggregate information such as whether a message is more effective with a particular software platform, which also indicates the preferences of its user. For example, message template “Welcome to our app $1. We hope you enjoy it.” may be more effective with Android devices 160 compared with iPhone devices 160.

In another example, the message server 110 may customise a message template for a particular user device 160 or user 162 based on their usage information and/or other user information, in which case specific notification messages are sent to the user device 160 or user 162.

### (c) Day and Time

Further enhancement of push delivery may be performed by assigning a day-based or time-based delivery rule to each message template, in which case Table 1(a) may be updated as follows:

TABLE 4(c)

| Weighting | | |
|---|---|---|
| factor | Message Template | Time |
| 12.5% | Welcome to our app $1. We hope you enjoy it. | 3:00 pm |
| 12.5% | Welcome to our app $1. We hope you enjoy it. | 7:00 pm |
| 12.5% | Hi $1. Nice to see you, enjoy our app! | 3:00 pm |
| 12.5% | Hi $1. Nice to see you, enjoy our app! | 7:00 pm |
| 12.5% | Hey $1, you look new. Welcome to our app! | 3:00 pm |
| 12.5% | Hey $1, you look new. Welcome to our app! | 7:00 pm |
| 12.5% | How is it going new guy? Come on in! | 3:00 pm |
| 12.5% | How is it going new guy? Come on in! | 7:00 pm |

The open rate of second notification messages and their delivery time are monitored to by the message server 110 to determine not only the best message template, but also when to send messages generated from the best message template. Although not shown in Table 4(a), the day on which each message should be sent may also be set, and its associated open rate tracked.

It will be appreciated by persons skilled in the art that numerous variations and/or modifications may be made to the invention as shown in the specific embodiments without departing from the scope of the invention as broadly described. The present embodiments are, therefore, to be considered in, all respects as illustrative and not restrictive.

It should also be understood that, unless specifically stated otherwise as apparent from the following discussion, it is appreciated that throughout the description, discussions utilizing terms such as “receiving”, “generating”, “retrieving”, “selecting”, “creating”, “determining”, or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices. Unless the context clearly requires otherwise, words using singular or plural number also include the plural or singular number respectively.

It should also be understood that the techniques described might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media (e.g. copper wire, coaxial cable, fibre optic media). Exemplary carrier waves may take the form of electrical, electromagnetic or optical signals conveying digital data streams along a local network or a publically accessible network such as the Internet.

It should also be understood that although the terms ‘first’, ‘second’ etc. may have been used herein to describe various elements, these elements should not be limited by these terms. These terms are only used to distinguish one element from another. For example, “first notification messages” could be termed “second notification messages”, and, similarly, “second notification messages” could be termed “first notification messages”, without departing from the scope of the present disclosure. The “first notification messages” and “second notification messages” are not the same messages.

1. A computer-implemented method of notification message generation, the method comprising a processing unit:
(a) generating a first message template based on a series of first notification messages intended for push delivery to recipient user devices, wherein the first message template includes non-personalised information identified as substantially common to the series of first notification messages, and one or more parameters representing personalised information identified in the stream of first notification messages;
(b) generating an alternative second message template that includes at least one variation from the non-personalised information in the first message template;
(c) using the first message template and second message template, generating a series of second notification messages for push delivery to the recipient user devices, wherein generating the second notification messages includes replacing the one or more parameters with personalised information associated with the recipient user devices; and
(d) based on usage information of the second notification messages, determining whether the first message template or the second message template is more effective.

2. The method of claim 1, wherein generating the second message template comprises varying the non-personalised information and/or one or more parameters identified in the first message by applying a set of one or more transformations on the first message template.

3. The method of claim 2, wherein the set of one or more transformations includes one or more of the following:
replacing a word in the first message template with a different word;
changing a style of the first message template;
reordering sentences in the first message template; and
removing a parameter in the first message template.

4. The method of claim 2, wherein the set of one or more transformations includes one or more of the following:
changing an urgency level of the first message template;
changing a style of the first message template based on an age group associated with the recipient user devices;
changing an intimacy level of the first message template;
changing a level of euphemism of the first message template;
changing a stylistic or punctuation component in the first message template;
changing a leetspeak level of the first message template;
changing an abbreviation level of the first message template;
changing a letter case of the first message template;
changing a type-to-token ratio of the first message template;
changing a level of hard or soft selling of the first message template;
changing a level of popular culture reference of the first message template; and
changing a level of stylistic influence from a range of subcultures.

5. The method of claim 4, wherein a mode or degree of a transformation in the set is adjustable by setting a continuous or discreet transformation parameter.

6. The method of any one of claim 2, wherein the set of one or more transformations is determined dynamically.

7. The method of any one of claim 2, wherein
generating the second message template comprises applying the set of one or more transformations on the first message template iteratively; and
each iteration comprises applying a transformation in the set to generate multiple candidate second message templates, and selecting one of the candidate second message templates for the next transformation until transformation is complete.

8. The method of claim 7, wherein one of the candidate second message templates is selected for the next transformation at each iteration based on one or more relatedness measures between each candidate second message template and a target message template.

9. The method of claim 8, wherein the one or more relatedness measures include one or more of the following:
a similarity measure relating to dialect usage;
a distance measure relating to number of edit operations required to modify the candidate second message template into the target message template;
a similarity measure relating to number of matching n-gram strings; and
a similarity measure relating to length of words and/or sentences.

10. The method of claim 1, further comprising:
assigning a first weighting factor to the first message template and a second weighting factor to the second message template, the first and second weighting factors each representing an average rate at which second notification messaged are generated from the respective message templates;
generating the series of second notification messages based on the assigned weighting factors; and
based on whether the first message template or the second message template is more effective, adjusting the first weighting factor and the second weighting factor.

11. The method of claim 1, further comprising, based on whether the first message template or the second message template is more effective, generating a third message template having at least one variation from the first message template or second message template, and replacing the first message template or the second message template with the third message template.

12. The method of claim 1, wherein the first message template and the second message template are each associated with one of the following:
a day on which a second notification message generated from the message template should be sent;
a time at which a second notification message generated from the message template should be sent;
a user cohort associated with a user device to which a second notification message generated from the message template should be sent;
a location associated with a user device to which a second notification message generated from the message template should be sent; and
a software platform associated with a user device to which a second notification message generated from the message template should be sent.

13. The method of claim 1, wherein the second notification messages are embedded with information gathering capability to collect the usage information at the user devices.

14. The method of claim 1, further comprising deriving, from on the usage information, one or more of the following:
whether a second notification message is opened, or not opened, at a user device if sent at a particular time or day, or both;
whether a second notification message is opened, or not opened, at a user device associated with a particular software platform;
whether a second notification message is opened, or not opened, at a user device associated with a particular user cohort; and
whether a second notification message is opened, or not opened, at a user device associated with a particular location.

15. The method of claim 14, further comprising deriving, from the usage information, user cohorts each relating to one or more of the following:
a time or day on which a second notification message is opened or not opened;
a location where a second notification message is opened or not opened;
type of user response to a second notification message; and
a property of a user device at which a second notification message is opened or not opened.

16. The method of claim 1, wherein the one or more parameters in the first message template or second message template are each represented as a reference character sequence.

17. The method of claim 1, wherein the first notification messages are generated by an application server and the second notification messages are sent to the user devices by a notification server.

18. The method of claim 17, wherein the second notification messages are generated when a request message is received from the application server.

19. A non-transitory computer readable medium with computer-executable instructions stored thereon that, when executed, cause a computer system to implement the method of notification message generation according to claim 1.

20. A computer system of notification message generation, the computer system comprises a processing unit operable to:
(a) generate a first message template based on a series of first notification messages intended for push delivery to recipient user devices, wherein the first message template includes non-personalised information substantially common to the series of first notification messages, and one or more parameters representing personalised information identified in the stream of first notification messages;
(b) generate an alternative second message template based on the first message template, wherein the second message template includes at least one variation from the first message template;
(c) using the first message template and second message template, generate a series of second notification messages for push delivery to the recipient user devices, wherein generating the second notification messages includes replacing the one or more parameters with personalised information associated with the recipient user devices; and
(d) based on usage information of the second notification messages, determine whether the first message template or the second message template is more effective.
